(19) United States
(12) Patent Application Publication
(10) Pub. No.: US 2017/0068474 A1
(43) Pub. Date: Mar. 9, 2017

(54) METHOD OF MANAGING DEFECTS IN RECORDING MEDIUM AND STORAGE APPARATUS

(71) Applicant: Kabushiki Kaisha Toshiba, Tokyo (JP)

(72) Inventor: Osamu Yoshida, Kawasaki Kanagawa (JP)

(21) Appl. No.: 15/055,934

(22) Filed: Feb. 29, 2016

Related U.S. Application Data
(60) Provisional application No. 62/215,500, filed on Sep. 8, 2015.

(51) Int. Cl. G06F 3/06

(52) U.S. Cl. CPC G06F 3/0619; G06F 3/0638; G06F 3/0685

(57) ABSTRACT

A storage apparatus includes nonvolatile first and second units, and a volatile third unit. Defect and management information are stored in the second unit. The defect information includes defect addresses related to defects in the first unit. The management information associates the defect information with each of segments obtained by dividing a recording area. The management information and at least part of the defect information are expanded in the third unit from the second unit. A control unit specifies a target segment including a target address to be accessed and selected segments based on the target address and the management information in the third unit in response to a request, and expands the part of the defect information from the second unit in the third unit.

### CROSS-REFERENCE TO RELATED APPLICATIONS

This application claims the benefit of U.S. Provisional Application No. 62/215,500, filed Sep. 8, 2015, the entire contents of which are incorporated herein by reference.

### FIELD

Embodiments described herein relate generally to a method of managing defects in a recording medium and a storage apparatus.

### BACKGROUND

In a storage apparatus such as a magnetic recording apparatus, defect management information concerning defects in a disk medium is written to a system area. The defect management information is referred to and stored (expanded) in RAM at the beginning of operating the storage apparatus. The defects include a primary defect detected at the stage of manufacturing of the storage apparatus and a grown defect detected while the storage apparatus is operating. The primary defect and the grown defect are managed as a primary defect list (PLIST) and a grown defect list (GLIST) by physical address (CHS) and logical address (LBA).

### BRIEF DESCRIPTION OF THE DRAWINGS

FIG. 1 is a block diagram schematically showing a storage apparatus to which a method of managing defects in a recording medium of an embodiment is applied.

FIG. 2A shows a management table stored in a nonvolatile memory shown in FIG. 1 and expanded in a volatile memory to manage defect information of the recording medium per segment and expand defect information of a requested segment in the volatile memory.

FIG. 2B shows GLIST expanded in FIG. 2A.

FIG. 2C shows PLIST expanded an FIG. 2A.

FIG. 3 is an explanatory diagram showing successive segments in the recording medium shown in FIG. 1 and a relationship between seek time of a head from a sector in a certain segment to a sector in another segment and time of m milliseconds required for writing to the nonvolatile memory.

FIG. 4 is a flowchart showing management of the defect information using the management table shown in FIG. 2.

FIG. 5 is a flowchart showing a process of loading a defect list from segments specified by the management table shown in FIG. 2 into the volatile memory shown in FIG. 1 in conjunction with the seek operation of the head.

FIG. 6 is a flowchart showing operation of expanding the defect list of the successive segments shown in FIG. 3 in the volatile memory shown in FIG. 1.

FIG. 7 is a flowchart showing a timing of loading the defect information into the volatile memory related to the seek operation of the head shown in FIG. 1.

FIG. 8 is a flowchart showing operation of setting priority levels added to the management table shown in FIG. 2.

FIG. 9A shows a table added to the management table shown in FIG. 2 to indicate a relationship between a priority level and parameters to determine the priority level.

FIG. 9B shows a table indicating a relationship between the parameters and the priority levels updated from those shown in FIG. 9A by the process shown in FIG. 8.

FIG. 9C shows a table indicating a relationship between the parameters and the priority levels updated from those shown in FIG. 9B by the process shown in FIG. 8.

FIG. 10A is a flowchart showing part of operation. of updating the segments of the defect list based on the priority levels in the volatile memory shown in FIG. 1.

FIG. 10B is a flowchart showing other part of operation of updating the segments of the defect list based on the priority levels in the volatile memory shown in FIG. 1.

### DETAILED DESCRIPTION

A storage apparatus to which a method of managing defects on a recording medium of embodiments is applied. is hereinafter described with reference to the drawings.

According to the embodiments, a storage apparatus comprises:

a nonvolatile first recording unit;

a nonvolatile second recording unit in which defect information and defect management information are stored, the defect information including a defect address related to a defect in a recording area of the first recording unit, the defect management information associating the defect information with each of segments obtained by dividing the recording area of the first recording unit;

a volatile semiconductor third recording unit in which the defect management information and at least part of the defect information are expanded from the second recording unit; and

a control unit configured to specify a target segment including a target address of the first recording unit to be accessed and selected segments not including the target address based on the target address and the defect management information in the third recording unit in response to a request to access the target address, and to expand part of the defect information associated with the target segment and the selected segments from the second recording unit in the third recording unit.

[Configuration of Disk Drive]

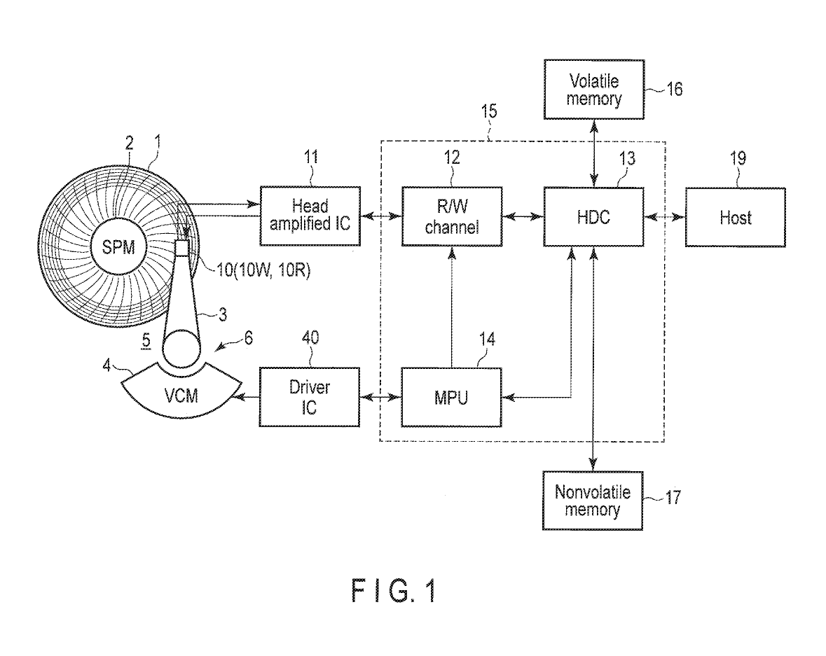

FIG. 1 schematically shows a storage apparatus (disk drive) of embodiments.

The disk drive comprises a head-disk assembly (HDA) 5, a head amplifier integrated circuit (head amplifier IC) 11 and a system controller 15 constituted by a single integrated circuit chip. The system controller 15 comprises a hard disk controller (HDC) 13, a read/write (R/W) channel 12, and a microprocessing unit (MPU) 14.

The HDA 5 comprises a disk 1 serving as a storage medium, a spindle motor (SPM) 2, an arm mechanism 3 including an arm equipped with a head 10, and a voice coil motor (VCM) 4. The arm mechanism 3 and the VCM 4 constitute a head positioning mechanism 6 to position the head 10.

The disk 1 is rotated by the spindle motor 2. The head 10 mounted on the arm mechanism 3 is moved above the disk 1 by driving of the VCM 4. The head 10 is located to face the disk surface of the disk 1 and is servo-controlled to be positioned at a target position.

The head 10 includes a write head 10W and a read head 10R mounted on a slider. The read head 10R reads data recorded in the disk 1 and the write head 10W writes data to the disk 1.

Cylinders (tracks) in which data is recorded are concentrically provided on the disk surface of the disk 1. A servo pattern serving as a servo area is recorded substantially in a radial direction on the disk surface of the disk 1. The cylinders are divided into regions by the servo pattern in a circumferential direction. An area between the servo patterns is allocated for a user data area in which user data can be recorded.

Servo data is recorded in the servo pattern. The servo data includes servo address information including track address data and sector address data, and a burst pattern.

The disk drive shown in FIG. 1 comprises a nonvolatile memory 17. The nonvolatile memory 17 is, for example, a nonvolatile semiconductor memory such as a flash memory or a NAND flash memory. The nonvolatile memory 17 maintains stored data even if the disk drive is powered off. The disk drive further comprises a volatile memory 16 constituted by, for example, SDPAM as a buffer memory. When the disk drive is powered on, write data transferred from a host 19 and read data to be transferred to the host 19 are temporarily stored in the volatile memory 16.

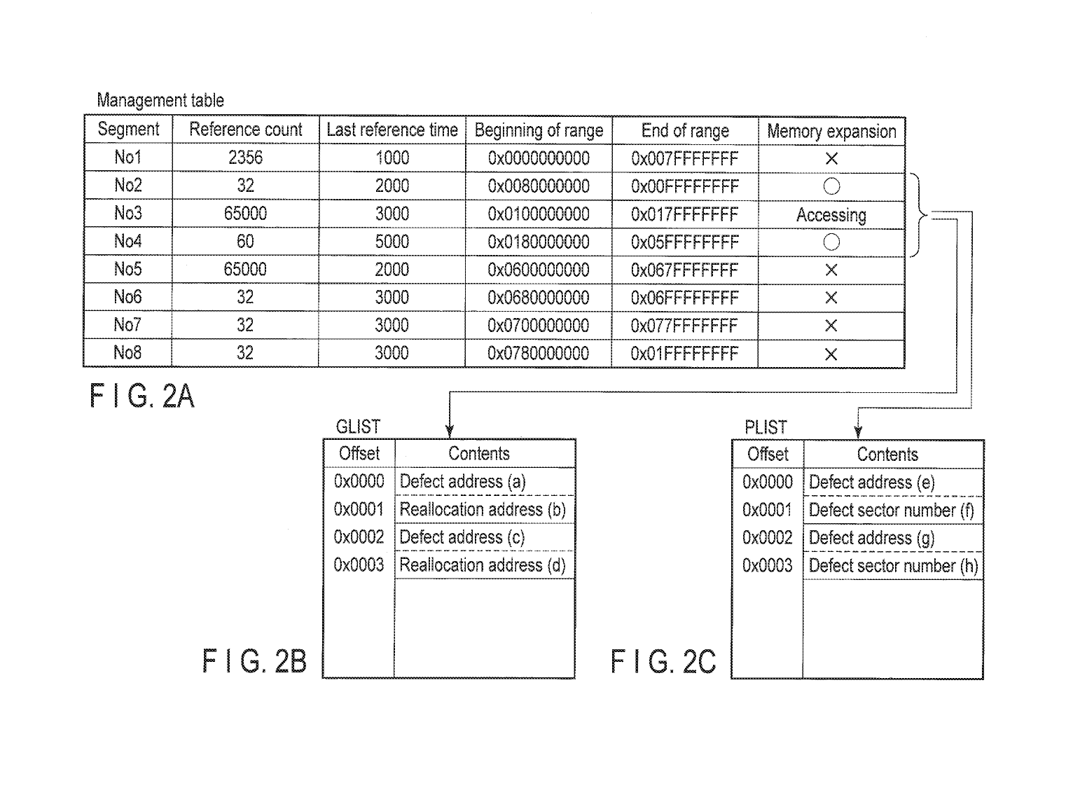

A system area is provided in the nonvolatile memory 17 or the disk 1. A management table including entire defect information, a primary defect list (PLIST) and a grown defect list (GLIST) shown in FIG. 2A, FIG. 2B and FIG. 2C are stored in the system area. PLIST and GLIST stored in the nonvolatile memory 17 or the disk 1 are hereinafter called primary defect information. As shown in FIG. 2A, the defect lists are divided into segments and are managed per segment by the management table.

The primary defect information is accessed while the disk drive is operating. If there is enough free space in the volatile memory 16 and the volume of the primary defect information is small, the entire primary defect information is expanded in the volatile memory 16. PLIST and GLIST expanded in the volatile memory 16 are hereinafter called secondary defect information. That is, the secondary defect information may include not only GLIST but also PLIST.

If the volume of the primary defect information is large and there is not enough free space to expand the entire primary defect information in the volatile memory 16, the management table is first expanded in the volatile memory 16. Then, part of the primary defect information that can be specified with reference to the segments described in the management table is read and expanded in the volatile memory 16 as the secondary defect information. The secondary defect information is updated in response to the operation of the disk drive. As necessary, the secondary defect information is written to the nonvolatile memory 17 or the disk 1 as the first defect information and updated. That is, part of the primary defect information stored in the nonvolatile memory 17 is expanded in the volatile memory 16 as the secondary defect information based on the management table.

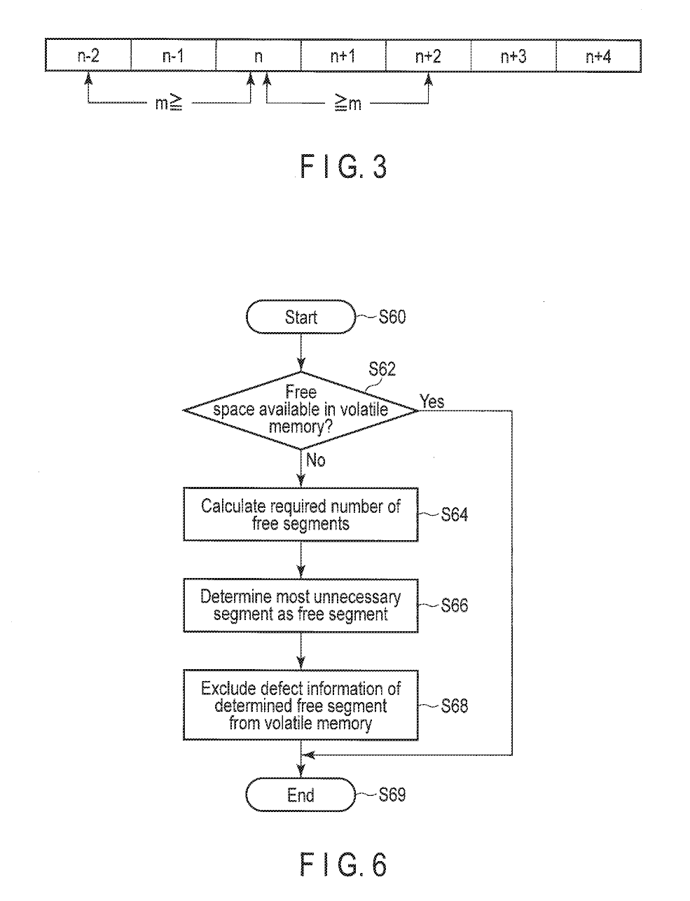

The management table shown in FIG. 2A includes the following items: “Segment Number (i.e., Segment)”, “Reference Count”, “Last. Reference Time”, “Beginning of Range”, “End of Range” and “Memory Expansion”. Ranges (areas) in the disk 1 divided as shown in FIG. 3 can be specified by “Segment Number”. “Reference Count” indicates the number of times an item specified by a segment number was referred to since a target address is in an area specified by the segment number. “Last Reference Time” indicates a time when an area specified by a segment number was last referred to. The unit of time may be arbitrarily set. “Beginning of Range” indicates a beginning address of an area specified by a segment number. “End of Range” indicates an end address of an area specified by a segment number. “Memory Expansion” indicates whether defect information of an area specified by a segment number was expanded in the volatile memory 16. More specifically, for example, the area of the disk 1 is divided into eight segments specified by segment numbers No1 to No8 in the management table shown in FIG. 2.

As the reference count of each of segments No3 and No5, a value indicating that the segment is referred to more frequently than the other segments, for example, the same value 65000, is described. The values 3000 and 2000 (relative values requiring no unit of quantity) are described as the last reference times of these segments, respectively. For example, the value 5000 is described as the last reference time of segment No4, which was last referred to. Segment No1 is, for example, a range from beginning address 0x0000000000 to end address 0x007FFFFFFF. The symbol “x” is described in the item of memory expansion of segment No1, which indicates that no defect information is expanded in the volatile memory 16. Segment No4 is defined by a range from beginning address 0x0180000000 to end address 0x05FFFFFFFF. If a target address requested to be accessed is in segment No3 adjacent to segment No4, for example, the symbol “o”is described in the item of “Memory Expansion” of segment No4, which indicates that defect information is expanded in the volatile memory 16. When a target address requested to be accessed is in segment No4, not only defect information of segment No4 but also defect information of at least segments No3 and No5 adjacent to segment No4 are expanded and the symbol “o” is described in the items of “Memory Expansion” of segments No3 and No5. Addresses of grown defect sectors included in the areas of the segments in which “Memory Expansion” is “o” and their reallocation addresses are read from the system area as part of GLIST as shown in FIG. 2B. In a similar way, addresses and sector numbers of primary defect sectors included in the areas of the segments in which “Memory Expansion” is “o” are read from the system area as part of GLIST as shown in FIG. 2C.

The start address of GLIST is determined by a pointer, and the items shown in FIG. 2B are determined by offset addresses from the start address of GLIST. In a similar way, the start address of PLIST is determined by a pointer, and the items shown in FIG. 2C are determined by offset addresses from the start address of PLIST. Addresses of the grown defect sectors and their reallocation address are described by LBA in the items of the read GLIST. In part of the read GLIST, for example, address (a) of a grown defect sector in segment 1 is described by LBA in an item specified by offset address 0x0000, and address (b) of a reallocated sector of the defect sector is described by LBA in an item specified by offset address 0x0001. Addresses and sector numbers of the primary defect sectors are described by CHS in the items of PLIST read by offset addresses. In part of PIST, for example, address (e) of a primary defect sector is described by CMS in an item specified by offset address 0x0000, and sector number (f) of the primary defect sector is described in an item specified by offset address 0x0001.

The segments shown in FIG. 2A are determined such that a time required for seeking from a sector in segment n to a sector in segment n+2 or n−2 or seeking in the opposite direction is a minimum seek time (Tmin) which is equal to or greater than m milliseconds. At this time, m milliseconds corresponds to a time required for reading defect information of a segment from the nonvolatile memory 17 and writing the read defect information to the volatile memory 16.

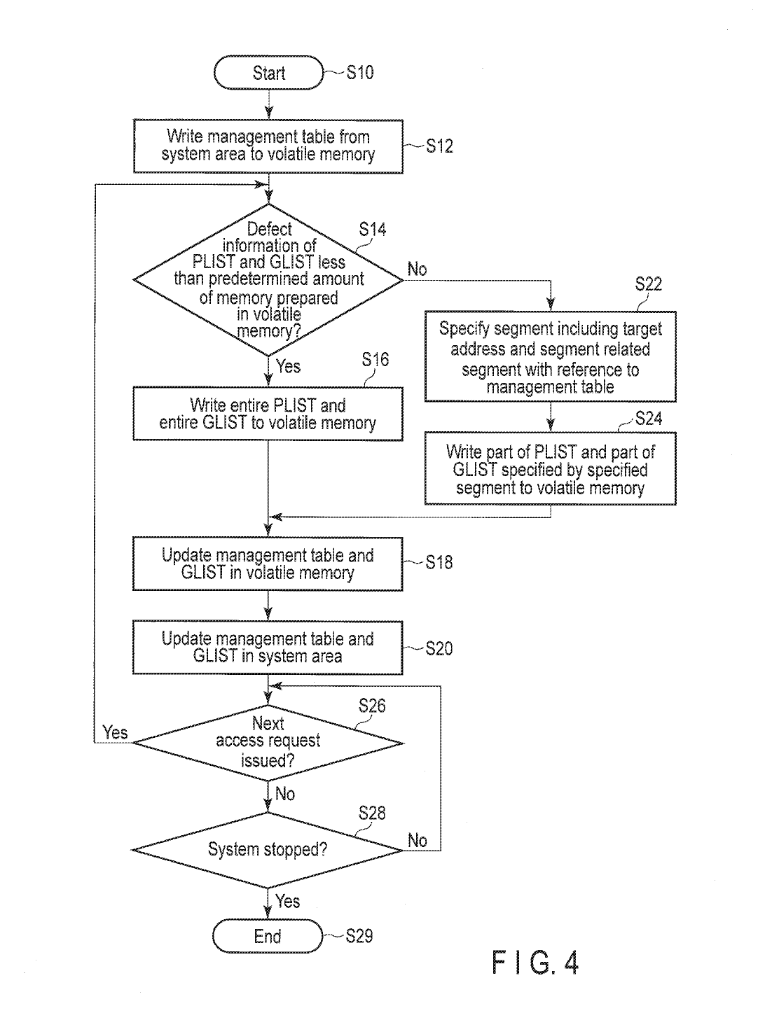

The management of the secondary defect information using the management table shown in FIG. 2A is performed as shown in FIG. 4. When the disk drive is powered on, the system is first initialized and then the disk 1 is rotated for a predetermined number of rotations. When reading and writing are made possible after the disk 1 is rotated, access management based on secondary defect information is started (S10). The MPU 14 reads the management table shown in FIG. 2A from the system area of the nonvolatile memory 17 and writes the table to the volatile memory 16 (S12). Next, whether the volume of defect information including PLIST indicating primary defects and GLIST indicating grown defects is less than a predetermined amount of memory prepared in the volatile memory 16 is confirmed (S14). If the volume of the defect information is less than the predetermined amount of memory (Yes in S14), the defect information including the whole of PLIST and GLIST is read from the system area of the nonvolatile memory 17 and written to the volatile memory 16 (S16).

After the defect information is written to the volatile memory 16, a target sector requested to be accessed is sought and the user data is read or written. If a new grown defect is detected in the process of write or read, the MPU 14 performs reallocation by rewriting the user data to a reallocated sector instead of the grown defect sector. The grown defect sector and the reallocation address are described in GLIST. Then, the MPU 14 updates the management table and GLIST in the volatile memory 16 and also updates those in the system area (S18 and S20). After that, whether the next access request is issued is confirmed (S26). If the next access request is issued (Yes in S26), the process returns to step S14 and the volume of defect information including PLIST and GLIST is confirmed. If the next access request is not issued (No in S26), the MPU 14 confirms whether the system is stopped (S28). If the system is not stopped (No in S28), the process returns to step 326 and the MPU 14 waits the next access. If the system is stopped (Yes in S28), the process is finished (S29).

In step S14, if the volume of the defect information is greater than the predetermined amount of memory (No in S14), the MPU 14 specifies a segment in the management table, for example, segment No3 shown in FIG. 2, from a target address requested to be accessed, and then specifies segments adjacent to the specified segment, for example, segments No2 and No4 shown in FIG. 2 (S22). Then, the MPU 14 reads part of GLIST belonging to the specified segment, for example, address (a) of a grown defect sector described in the item specified by offset address 0x0000, address (b) of a reallocated sector described in the item specified. by offset address 0x0001, etc., and writes the read part of GLIST to the volatile memory 16. The MPU 14 also reads part of PLIST belonging to the specified segment, for example, address (e) and segment number (f) of a primary defect sector described in the item specified by offset address 0x0000, etc., and writes the read part of PLIST to the volatile memory 16 (S24). After that the MPU 14 accesses the target sector requested to be accessed and write or read the user data. If a new grown defect is detected in the process of write or read, the MPU 14 performs reallocation by rewriting the user data to a reallocated sector instead of the grown defect sector, and the process proceeds to step S18.

### First Embodiment

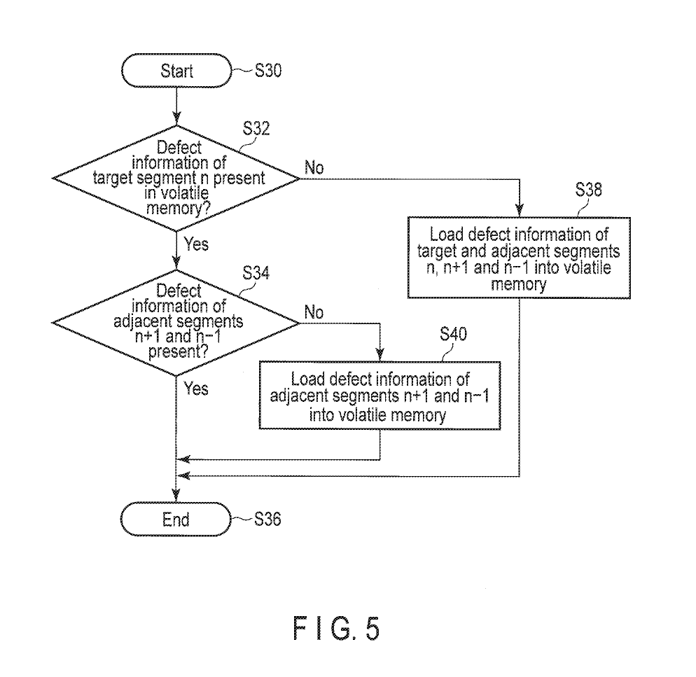

More specifically, the step of reading part of PLIST and part of GLIST, i.e., part of defect information (S24), is performed. by the MPU 14 as a process of loading the defect information into the volatile memory 16 as shown in FIG. 5. In the first embodiment, specified segments are target segment n including a target sector requested to be accessed and segments n+1 and n−1 adjacent to the target segment. When the loading process is started (S30), whether defect information of target segment n, for example, part of GLIST and part of PLIST belonging to segment No3, is expanded in the volatile memory 16 is confirmed (S32). If the defect information of target segment n is not expanded (No in S32), the system area of the nonvolatile memory 17 is accessed, the management table shown in FIG. 2 is referred to, and defect information including part of GLIST and part of PLIST belonging to target segment n, for example, segment No3, and defect segments n+1 and n−1 adjacent to the target segment, for example, segments No2 and No4, is expanded in the volatile memory 16 (S38). If the defect information of target segment n is expanded (Yes in S32), whether defect information of adjacent segments n+1 and n−1 of the target segment, for example, GLIST and PLIST belonging to segments No2 and No4, is expanded in the volatile memory 16 is confirmed (S34). If the defect information of the adjacent segments is riot expanded (No in S34), the management information shown in FIG. 2 of the system area of the nonvolatile memory 17 is referred to, defect information of adjacent segments n+1 and n−1 of target segment n, for example, GLIST and PLIST belonging to segments No2 and No4 adjacent to segment No3, is accessed, and the defect information is expanded in the volatile memory 16 (S40). The entire process is finished (step S36) if the defect information of adjacent segments n+1 and n−1 of the target segment is expanded (Yes in S34), the loading of the defect information of adjacent segments n+1 and n−1 of the target segment is completed, or the step S38 is completed.

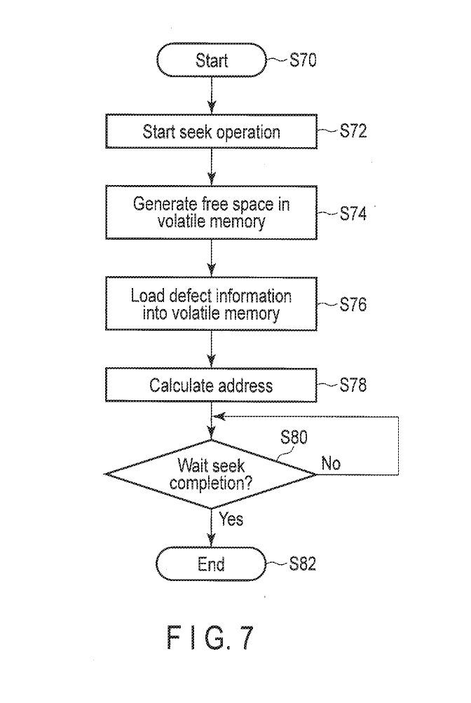

If a new access request is issued, the process of steps S30 to S40 is performed again, and defect information of next target segment (n′) including a target sector requested to be accessed and adjacent segments (n′30 1) and (n′−1) of the next target segment is loaded. into the volatile memory 16. In the process of loading, if there is enough free space in an area prepared in the volatile memory 16 to store the defect information, the defect information of the previous target segment n and adjacent segments n+1 and n−1 may be left in the volatile memory 16. If there is not enough free space to store the defect information in the area of the volatile memory 16, a process of making free space is performed as shown in FIG. 6. More specifically, in step S24 of FIG. 4, if the MPU 14 determines that there is not enough space in the volatile memory 16 when reading part of PLIST and part of GLIST, the process of making free space is performed as shown in FIG. 6.

When the process of making free space shown in FIG. 6 is started (S60), the MPU 14 checks the size of free space in the memory area of the volatile memory 16. If there is enough free space to expand the defect information in the memory area of the volatile memory 16 (No in S62), the process is finished (S69). If there is not enough free space in the memory area of the volatile memory 16 (Yes in S62), the MPU 14 calculates the number of free segments required to be expanded in the memory area of the volatile memory 16 in response to an access request to a new target sector (S64). Depending on the required number of free segments, a segment deemed unnecessary most is determined as a free segment from the segments expanded in the memory area of the volatile memory 16 (S66). A segment of which reference count described in the management table is the lowest may be determined as a free segment as described later. Alternatively, a free segment may be determined based on priority levels determined according to the reference counts as described later. After the free segment is determined, the MPU 14 excludes the determined free segment from the memory area of the volatile memory 16 (S68). As a result, enough free space to load the defect information is secured in the memory area of the volatile memory 16, and the process is therefore finished (S69).

When securing the free space, for example, a segment of which reference count described in the management table is the lowest is determined as a free segment and the determined free segment is deleted. When defect information of four segments, for example, segments 1 to 4 shown in FIG. 2, is expanded in the volatile memory 16 and a request to access a sector in segment 5 is issued, defect information of the adjacent segment 4 is maintained, segments 1 and 2 are determined as free segments, and defect information of segments 1 and 2 is deleted. Then, defect information of segments 5 and 6 is expanded in the memory 16 instead of the defect information of segments 1 and 2. As shown in FIG. 2, segment 1 was referred to 2356 times and the last reference time is 1000. Segment 2 was referred to 32 times and the last reference time is 2000. Segment 3 was referred to 65000 times and the last reference time is 3000. Comparing these values has shown that a sector in segment 3 is accessed more frequently than sectors in segments 1 and 2. Therefore, defect information of segment 3 is maintained and defect information in segment 2 having the lowest access frequency and the oldest reference time is deleted. Segment 1, which is more distant from segment 5 than segment 3 and accessed less frequently than segment 3, is also deleted.

As described above, defect information of a segment including a target sector having a high probability of being accessed can be always prepared by maintaining a frequently accessed segment, which can prevent performance degradation caused by overhead of write time.

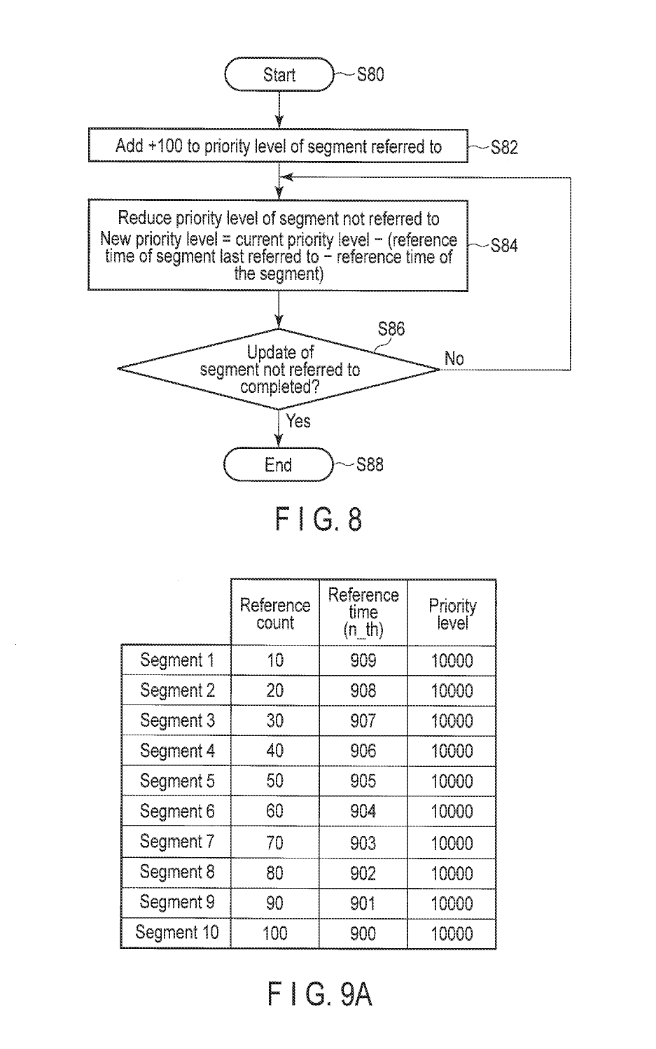

In conjunction with the loading of the defect information in step S24 of FIG. 4, a seek operation of the target address is performed as shown in FIG. 7. If a request to access the target address is issued (S70), the MPU 14 starts the seek operation of the head 10 (S72). Then, the MPU 14 confirms whether there is free space in the memory area of the volatile memory 16. If there is not enough free space, the MPU 14 generates free space by the process shown in FIG. 6 (S74). Next, defect information of a segment including the target address requested to be accessed and adjacent segments is loaded into the volatile memory 16 (S76). The MPU 14 calculates an address from the current sector to the target address with reference to the defect information (S78). The MPU 14 makes the head 10 seeking and confirms completion of the seek (S80). When the seek is completed and it becomes possible to access the target address, the process is finished (S82).

As described above, defect information of segments near the accessed segment is expanded in the volatile memory 16. The volume of defect information resident in the memory 16 can be thereby reduced without performance degradation caused by overhead. Since the management table shown in FIG. 2A and minimum required defect information, at least part of GLIST, are expanded in the memory 16, a size of grown defect registered in the nonvolatile memory 17 is not limited by the size of the nonvolatile memory 17, and a size of defect information managed by the management table can be greater than a memory size of the area of the volatile memory 16 in which the defect information is stored. For example, even large defect sectors such as mega sectors can be registered in the nonvolatile memory 17, part of the defect information can be expanded in the volatile memory 16 and a target address can be efficiently sought.

### Second Embodiment

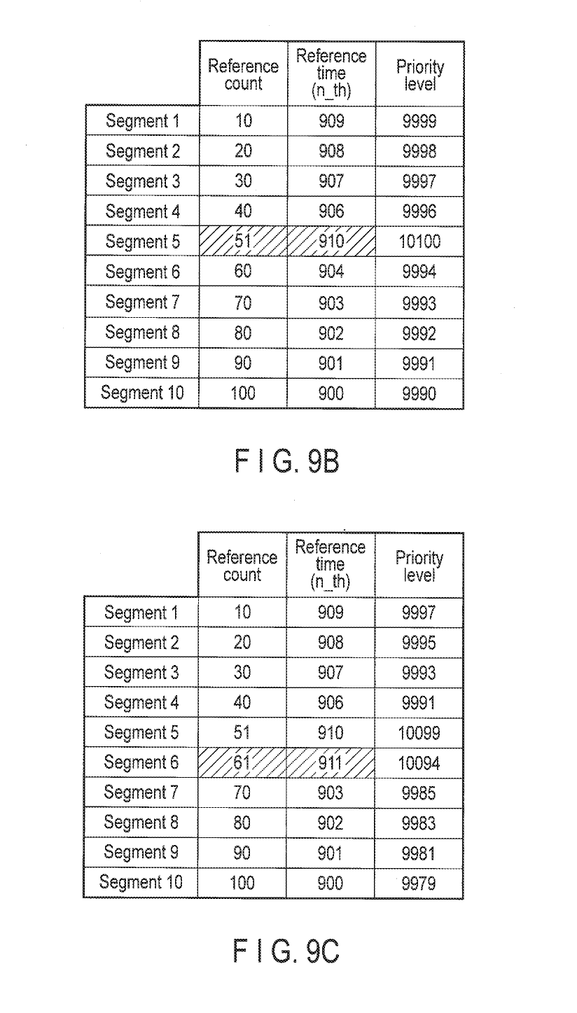

Next, an embodiment in which defect information of a segment having a high probability of being referred to is left in the memory based on priority levels instead of or together with segments n+1 and n−1 adjacent to segment n is described with reference to FIG. 8 to FIG. 11B. When determining a segment deemed unnecessary most in step S66 of FIG. 6, defect information of a segment having a high probability of being referred to is left in the memory and defect information of the unnecessary segment is deleted from the memory, based on the priority levels.

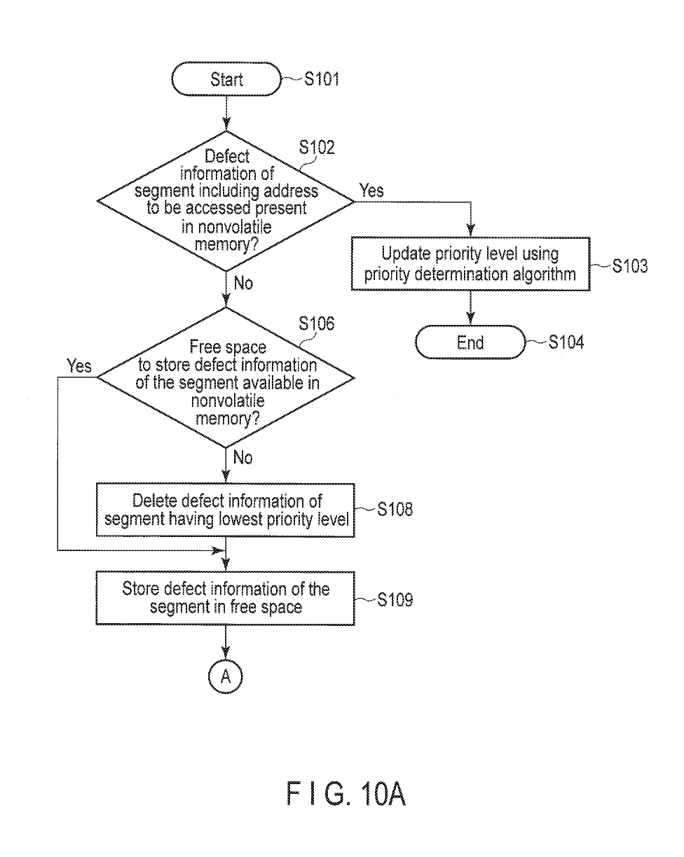

In the second embodiment, for example, the item of priority levels is added to the management table as shown in FIG. 9A to FIG. 9C, and a segment specified based on the priority levels is expanded in the volatile memory 16. Each priority level is increased or decreased by the process shown in FIG. 8.

Each time a target sector is accessed, the management table is referred to and the priority levels are updated (S80). It is assumed that the management table is in a state shown in FIG. 9A. When the target sector is accessed, the segments of the management table are referred to and a frequency is added to a segment including the target sector. For example, frequency+100 is added at the time of 910. For example, when a sector in segment 5 shown in FIG. 9A is accessed, the reference count of segment 5 is increased from 50 to 51, and the priority level is updated to 1100 by adding +100 to the initial priority level 1000 as shown in FIG. 9B (S82). A priority level of each segment not referred to is updated based on the current priority level, the reference time of the segment and the reference time of the referred segment (reference time of the last referred segment) by the following expression (S84):

new priority level=current priority level−(reference time of last referred segment−reference time of this segment)

For example, a new priority level of segment 1 not referred to is calculated as follows:

10000 (current priority level)−{910 (reference time of last referred segment)−909 (reference time of segment 1)}=10000−1=9999 (new priority level)

In a similar way, for example, a new priority level of segment 6 not referred to is calculated as follows:

10000 (current priority level)−{910 (reference time of last referred segment)−904 (reference time of segment 6)}=10000−6=9994 (new priority level)

New priority levels are calculated until update of all the segments not referred to is completed (No in step S86). When the update of all the segments not referred to is completed (Yes in step S86), the processing is finished (S88).

In a similar way, for example, if segment 6 is accessed after the access to the sector in segment 5 is finished and the update of the management table is completed, the reference count of segment 6 is updated from 60 to 61 and the priority level is updated to 10094 by adding +100 to the priority level 9994 as shown in FIG. 9C (S82). A priority level of each segment not referred to is updated used on the current priority level, the reference time of the segment and the reference time of the referred segment (reference time of the last referred segment) (S84).

For example, a new priority level of segment 1 not referred to is calculated as follows:

9999 (current priority level)−{911 (reference time of last referred segment)−909 (reference time of segment 1)}=9999−2=9997 (new priority level)

In a similar way, for example, a new priority level of segment 5 not referred to is calculated as follows:

10100 (current priority level)−{911 (reference time of last referred segment)−910 (reference time of segment 5)}=10100−1=10099 (new priority level)

The heading of reference times includes the ordinal number (nth), which means that reference times at the n-th access are indicated in the table and is updated each time a target sector is accessed.

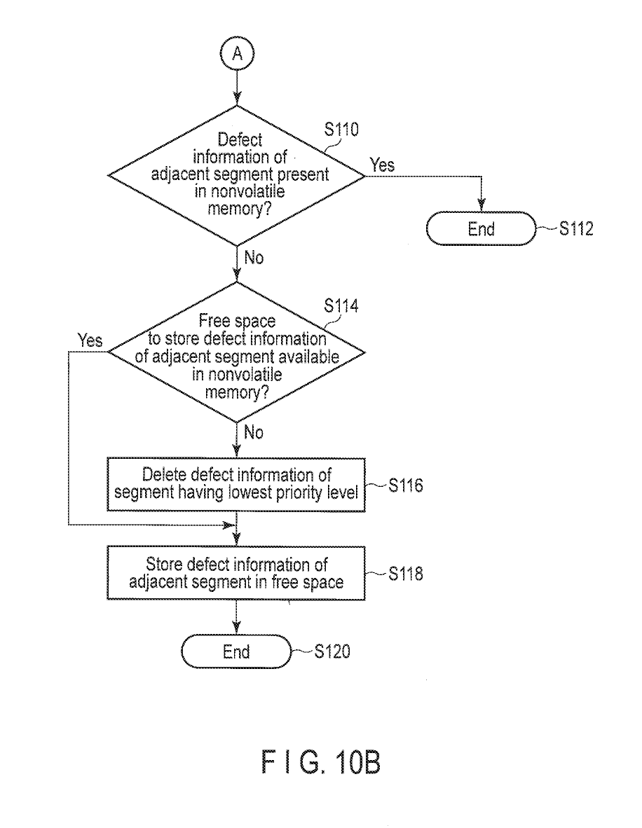

The management of defect information using the management table in which the priority levels are updated as shown in FIG. 8 is described with reference to FIG. 10A and FIG. 10B.

When the process is started (step 101), whether defect information of a segment including a target address requested to be accessed is in a buffer area of the volatile memory 16 is confirmed (step 102). if the defect information is in the buffer area of the volatile memory 16 (Yes in step 102), the priority levels are updated by using the priority determination algorithm described above with reference to FIG. 8, and the process is finished (S103 and S104).

If the defect information of the segment including the target address requested to be accessed is not in the buffer area of the volatile memory 16 (No in step 102), whether there is free space to store the defect information of the segment including the target address requested to be accessed in the volatile memory 16 is confirmed (step 106). If there is no free space (No in step 106), the management table is referred to, defect information of a segment having the lowest priority level is deleted from the defect information expanded in the volatile memory 16, and free space is thereby secured (step 108). If there is free space (Yes in step 106) or free space is secured in step S108, the management table is referred to and defect information of the segment including the address to be accessed is stored in the free space (step 109). After that, whether defect information of segments adjacent to the segment is in the volatile memory 16 is confirmed (step 110). If the defect information of the adjacent segments is in the volatile memory 16 (Yes in step 110), the process is finished (step 112).

If the defect information of the adjacent segments is not in the volatile memory 16 (No in step 110), whether there is free space to store the defect information. of the adjacent segments in the volatile memory 16 is confirmed (step 114). If there is no free space (No in step 114), the management table is referred to, defect information of a segment having the lowest priority level is deleted from the defect information expanded in the volatile memory 16, and free space is thereby secured (step 116). If there is free space (Yes in step 114) or free space is secured in step S116, the management table is referred to, defect information of the adjacent segments is stored in the free space and the process is finished (steps 118 and 120).

The segments described in the management table shown in FIG. 2 are determined as follows, and increased and decreased as necessary.

As described above, when the size of defect information is small and the entire defect information can be expanded in the volatile memory 16, k segments, for example, eight segments, are set. As defects are increased and the size of the defect information becomes larger, new segments are added to the management table by dividing each segment into two and. assigning new segment numbers.

More specifically, when the total size of defect information is less than a size that can be expanded in the volatile memory 16, all the area of the disk 1 is divided into eight by logical block address (LBA) of sectors like the segments of the management table shown in FIG. 2, and segments 1 to 8 are determined. Then, the management table and the entire defect information are expanded in the volatile memory 16. For example, at most about 2000 defects can be registered in each segment. At least eight segments and at most, for example, about 1000 segments can be registered in the management table.

The number of registrations in the management table can be increased from the initial number, i.e., eight segments, to the maximum number, i.e., 1000 segments. Therefore, the information. on up to 2,000,000 defects (2000 defects×1000 segments) can be registered.

When new defect information is frequently added to one of existing segments, the segment is divided in half. The halves of the segment are registered in the management table as new segments, and the original segment is deleted. The new two segments are registered so as to inherit the reference count, the reference time and the priority level of the original segment. When defect information is further added to fill either of the new segments, the segment is further divided in half. The halves of the segment are registered. in the management table as new segments, and the original segment is deleted in a similar way. The new two segments inherit the reference count, the reference time and the priority level of the original segment.

As described above, according to the embodiments, the manufacturing yield can be increased and the failure frequency of apparatuses in user environment can be reduced.

In the above-described embodiments, the system area is provided in the nonvolatile memory 17 and the management table including the entire defect information is stored in the system area. However, the embodiments may be applied to a disk drive without nonvolatile memory 17 in which a system area is provided in a disk 1 of the disk drive and a management table including entire defect information is stored in the system area.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage apparatus comprising:
a nonvolatile first recording unit;
a nonvolatile second recording unit in which defect information and defect management information are stored, the defect information including a defect address related to a defect in a recording area of the first recording unit, the defect management information. associating the defect information with each of segments obtained by dividing the recording area of the first recording unit;
a volatile semiconductor third recording unit in which the defect management information and at least part or the defect information are expanded from the second recording unit; and
a control unit configured to specify a target segment including a target address of the first recording unit to be accessed and selected segments not including the target address based on the target address and the defect management information in the third recording unit in response to a request to access the target address, and to expand part of the defect information associated with the target segment and the selected. segments from the second recording unit in the third recording unit.

2. The storage apparatus of claim 1, wherein
the defect management information includes address range information which specifies a range of each of the segments, and
the part of the defect information expanded in the third recording unit includes a defect address in a range specified by the address range information corresponding to the target segment and the selected segments.

3. The storage apparatus of claim 1, wherein
the defect information further includes a reallocation address by which the defect address is replaced,
the third recording unit has a predetermined memory size, and
the control unit compares a data size of the defect management information and the defect information with the predetermined memory size, and expands the defect management information and the defect information in the third recording unit when the data size is less than the memory size.

4. The storage apparatus of claim 1, wherein
the defect information includes primary defect information and a grown defect list,
the primary defect list includes a defect address of a primary defect, and
the grown defect list includes a defect address of a grown defect which has subsequently occurred.

5. The storage apparatus of claim 1, wherein
the control unit determines a next target segment and next selected segments based on a next target address to be accessed, and expands next part of the defect information from the second recording unit in the third recording unit with reference to the defect management information, the next part of the defect information including a defect address in a range belonging to the next target segment and the next selected segments.

6. The storage apparatus of claim 1, wherein
the selected segments include a first segment adjacent to the target segment, and a second segment adjacent to the first segment and includes a next target address, wherein the second segment is determined such that a seek time required for accessing the second segment from the target segment is equal to or greater than a predetermined time.

7. The storage apparatus of claim 6, wherein
the predetermined time is a time required for reading data of one of the segments from the second recording unit and writing the read data to the third recording unit.

8. The storage apparatus of claim 1, wherein
the control unit leaves the part of the defect information expanded in the third recording unit, determines a next range belonging to a next target segment and next selected segments based on a next target address to be accessed, and expands next part of the defect information including a defect address in the next range in the third recording unit with reference to the defect management information.

9. The storage apparatus of claim 1, wherein
the selected segments include segments determined depending on priority levels, and
each of the priority levels is determined according to a reference count and a last reference time of a corresponding segment.

10. A method of managing a defect in a recording area of a nonvolatile first recording unit, the method comprising:
storing defect information and defect management information in a nonvolatile second recording unit, the defect information including a defect address related to the defect, the defect management information associating the defect information with each of segments obtained by dividing the recording area of the first recording unit;
expanding the defect management information and at least part of the defect information from the second recording unit in a volatile semiconductor third storage;
specifying a target segment including a target address of the first recording unit to be accessed and selected segments not including the target address based. on the target address and the defect management information in the third recording unit in response to a request to access the target address; and
expanding part of the defect information associated with the target segment and the selected segments from the second recording unit in the third recording unit.

11. The method of claim 10, wherein
the defect management information includes address range information which specifies a range of each of the segments, and
the part of the defect information expanded in the third recording unit includes a defect address included. in a range specified by the address range information corresponding to the target segment and the selected segments.

12. The method of claim 10, wherein
the defect information further includes a reallocation address by which the defect address is replaced,
the third recording unit has a predetermined memory size,
a data size of the defect management information and the defect information is compared with the predetermined memory size, and
the defect management information and the defect information are expanded in the third recording unit when the data size is less than the memory size.

13. The method of claim 10, wherein
the defect information includes primary defect information and a grown defect list,
the primary defect list includes a defect address of a primary defect, and
the grown defect list includes a defect address of a grown defect which has subsequently occurred.

14. The method of claim 10, further comprising:
determining a range belonging to a next target segment and next selected segments based on a next target address to be accessed; and
expanding next part of the defect information from the second recording unit to the third recording unit with reference to the defect management information,
wherein the next part of the defect information includes a defect address in a range belonging to the next target segment.

15. The method of claim 10, wherein
the selected segments include a first segment adjacent to the target segment, and a second segment adjacent to the selected segments and includes a next target address, wherein the second segment is determined such that a seek time required for accessing the second segment from the target segment is equal to or greater than a predetermined time.

16. The method of claim 15, wherein
the predetermined time is a time required for reading data of one of the segments from the second recording unit and writing the read data to the third recording unit.

17. The method of claim 10, further comprising:
leaving the part of the defect information expanded in the third recording unit;
determining a next range belonging to a next target segment and next selected segments based on a next target address to be accessed; and
expanding next part of the defect information including a defect address in the next range in the third recording unit with reference to the defect management information.

18. The method of claim 10, wherein
the selected segments include segments determined depending on priority levels, and
each of the priority levels is determined according to a reference count and a last reference time of a corresponding segment.
